(19) United States
(12) Patent Application Publication
(10) Pub. No.: US 2019/0126158 A1
(43) Pub. Date: May 2, 2019

(54) TRACK LAYOUT IDENTIFICATION TECHNIQUES

(71) Applicant: SPHERO, INC., Boulder, CO (US)

(72) Inventors: David Hygh, Broomfield, CO (US); Quentin Michelet, Arlington, VA (US); Michael Byrd, Broomfield, CO (US)

(73) Assignee: SPHERO, INC., Boulder, CO (US)

(21) Appl. No.: 15/893,188

(22) Filed: Feb. 9, 2018

Related U.S. Application Data
(60) Provisional application No. 62/577,866, filed on Oct. 27, 2017.

(51) Int. Cl. A63H 18/02; G06K 7/10; A63F 9/14

(52) U.S. Cl. CPC A63H 18/021; G06K 7/10009; G09B 19/00; A63H 18/028; A63F 9/143

(57) ABSTRACT

Aspects of the present disclosure relate to track layout identification techniques. As an example, a set of track segments may be arranged in a certain order to form a track. A variety of track segment types may be used to form the track, and different combinations of the track segments may yield a track having varying characteristics. In an example, each track segment may comprise of a shift register, which may provide information to a base track segment relating to the order of the track segments and the track segment types that comprise the track. In some examples, the base track segment may relay the information to a computing device. Accordingly, the information may be used to determine a track layout, which may in turn be used to provide, for example, the ability for someone else to reproduce the track configuration.

### CROSS-REFERENCE TO RELATED APPLICATIONS

This application claims priority to U.S. Provisional Application No. 62/577,866, entitled “Track Layout Identification Techniques,” filed on Oct. 27, 2017, the entire disclosure of which is hereby incorporated by reference in its entirety.

### BACKGROUND

A track (e.g., for driving/racing a toy car, for guiding a robot, etc.) may be constructed from a set of track segments by arranging the track segments in a variety of different orders. However, it may be difficult to programmatically identify the type of track segments used and the order in which the track segments are arranged.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to track layout identification techniques. As an example, a set of track segments may be arranged in a certain order to form a track. A variety of track segment types may be used to form the track, and different combinations of the track segments may yield a track having varying characteristics (e.g., length, difficulty, shape, etc.). In an example, each track segment may comprise of a shift register, which may provide information to a base track segment relating to the order of the track segments and the track segment types that comprise the track. In some examples, the base track segment may relay the information to a computing device. Accordingly, the information may be used to determine a track layout (e.g., which types of track segments were used to construct the track, the order in which the track segments are connected, etc.), which may in turn be used to provide, for example, the ability for someone else to reproduce the track configuration.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A illustrates an overview of an example system for track layout identification.

FIG. 1B illustrates an overview of example aspects of a track segment.

FIG. 1C illustrates an overview of an example circuit diagram for a track segment.

FIG. 2A illustrates an overview of an example method for receiving track segment information at a base track segment.

FIG. 2B illustrates an overview of an example method for communicating track segment information by a track segment.

FIG. 2C illustrates an overview of an example method for communicating track information by a smart track segment.

FIGS. 3A-3B illustrate overviews of example user interface elements according to aspects disclosed herein.

FIG. 4 illustrates an example operating environment in which one or more of the present embodiments may be implemented.

### DETAILED DESCRIPTION

A track may be used for any of a variety of purposes, including, but not limited to, racing a toy car, guiding a robot, or for a model train. In an example, the track may be comprised of one or more track segments, which may be rearranged to form tracks having different shapes, sizes, or difficulties, among other varying attributes. In another example, the track may be comprised of different track segment types, such as straight track segments, curved track segments, and exotic track segments (e.g., a vertical loop, banked turns, etc.), among other track segments. In an example, one or more “base” track segments may be used to provide communication functionality for the rest of the track. A base track segment may provide additional functionality as compared to other track segments, such as a car launcher or a timer, among other functionality. In some examples, the track may be closed, such that an object on the track may ultimately return to an initial starting position (e.g., a circular track, a figure eight, etc.). In other examples, the track may not be closed, and may instead have a starting point and ending point that are not connected.

In an example, a computing device may be used to provide a user experience associated with the track. For example, a user of the computing device may be provided with a library of possible track arrangements, instructions for building a track using a set of track segments, or a leaderboard of race times associated with a specific track configuration, among other functionality. In order to provide such functionality, the computing device may determine the track layout according to aspects disclosed herein.

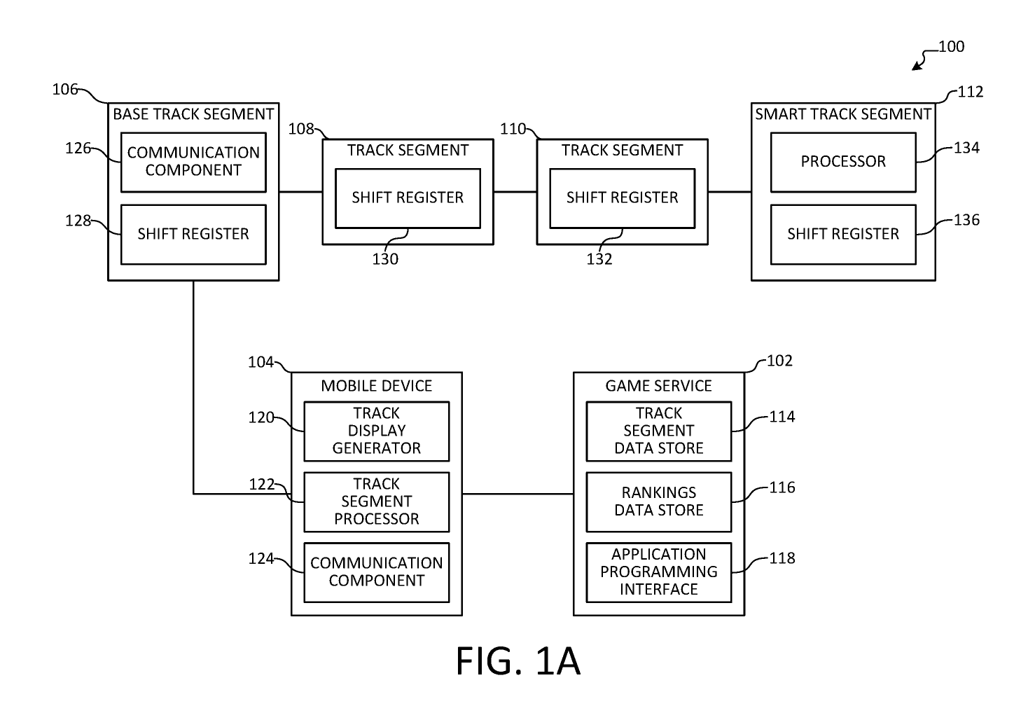

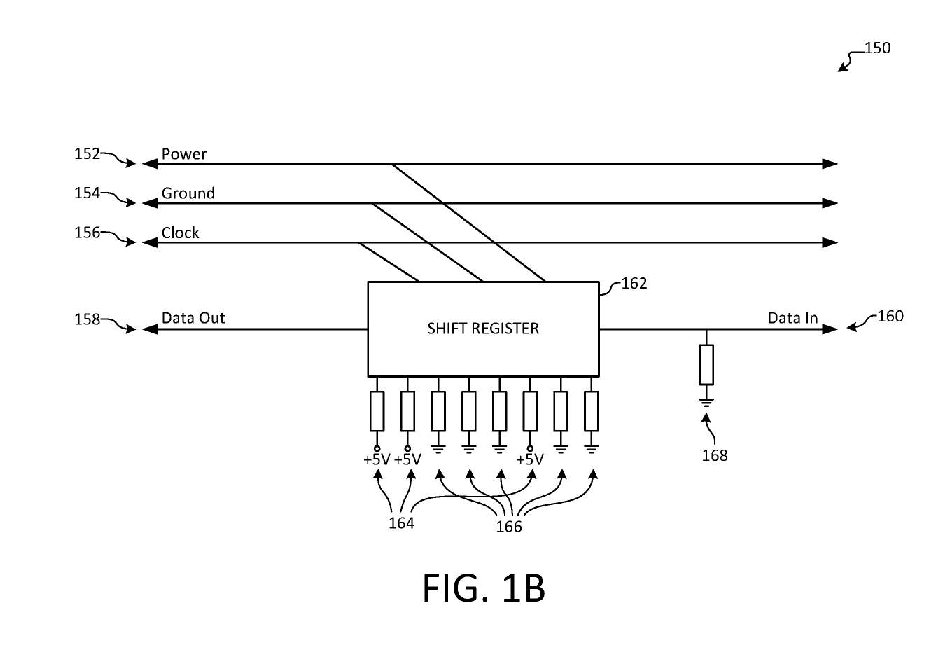

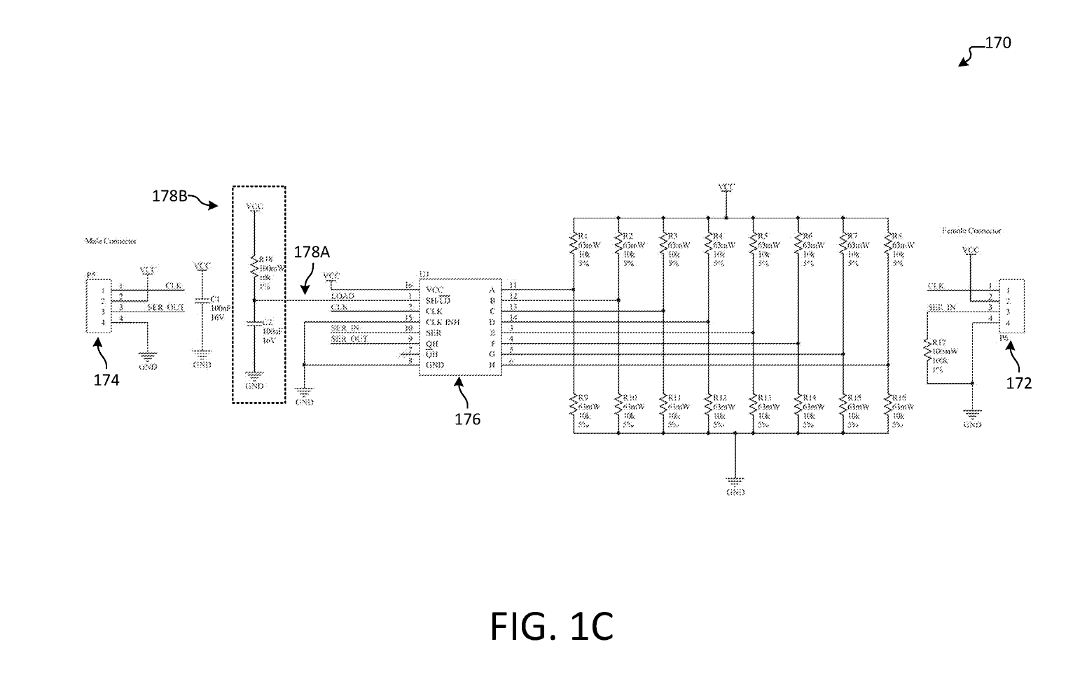

FIG. 1A illustrates an overview of an example system 100 for track layout identification. As illustrated, system 100 is comprised of game service 102, mobile device 104, base track segment 106, track segment 108, track segment 110, and smart track segment 112. Track segments 106-112 are illustrated as being connected, and may represent a specific track layout comprising track segments 106-112 in the order illustrated in FIG. 1A. In some examples, track segments 106-112 may be physically connected (e.g., using one or more wires, leads, contacts, etc.), magnetically connected, and/or connected using radio frequencies (e.g., Bluetooth, Bluetooth Low Energy, Wi-Fi, etc.). It will be appreciated that while example connection techniques are described herein, other techniques may be used without departing from the spirit of this disclosure.

Base track segment 106 may communicate with mobile device 104. In some examples, the communication may be wired or wireless (e.g., Bluetooth, Bluetooth Low Energy, Wi-Fi, infrared light, etc.). In an example, base track segment 106 may provide track layout information to mobile device 104, according to aspects disclosed herein. In another example, mobile device 104 may generate a display of the track based on the received track layout information. Mobile device 104 may communicate with game service 102, which may provide information used to identify track segments, leaderboard functionality relating to specific track layouts, and/or other functionality. In some examples, mobile device 104 may communicate content (e.g., light patterns, audio, etc.) to base track segment 106, which base track segment 106 may convey to a user using speakers, LEDs, or other components (not pictured).

In an example, game service 102 may provide a user experience associated with track segments 106-112. In some examples, game service 102 may be provided by one or more computing devices. As illustrated, game service 102 is comprised of track segment data store 114, rankings data store 116, and application programming interface (API) 118. Track segment data store 114 may comprise information relating to track segment types and track segment layouts, among other information. As an example, mobile device 104 may retrieve information from track segment data store 114 of game service 102 in order to determine a track segment type based on an identifier associated with one of track segments 106-112, or may use the information to provide instructions on how to create a track having a specific layout as stored in track segment data store 114. While example content is discussed herein, it will be appreciated that track segment data store 114 may store any of a wide variety of information relating to track segments.

Game service 102 may also comprise rankings data store 116, which may aggregate data received from multiple devices, such as mobile device 104. As an example, rankings data store 116 may store time information associated with a toy race car completing a track having a certain layout. In some examples, the layout may be stored by track segment data store 114, such that the time information may be stored by rankings data store 116 and associated with the layout in track segment data store 114. In such examples, mobile device 104 may receive time information from rankings data store 116 in order to provide a leaderboard (e.g., having the a ranked listing of times) associated with a specific track layout. In another example, mobile device 104 may provide time information for storage by rankings data store 116. The time information received from mobile device 104 may be associated with a specific track layout, as may be confirmed based on layout information from base track segment 106 according to aspects disclosed herein.

API 118 of game service 102 may be used by mobile device 104 to interact with game service 102. As an example, API 118 may be used to access information from track segment data store 114 and/or rankings data store 116. In another example, API 118 may be used to add, remove, and/or update information stored by track segment data store 114 and/or rankings data store 116. While example functionality of game service 102 and API 118 is described herein, it will be appreciated that other functionality may be provided.

Mobile device 104 may be a computing device, including, but not limited to, a mobile computing device, a tablet computing device, a laptop computing device, or a desktop computing device. As illustrated, mobile device 104 is comprised of track display generator 120, track segment processor 122, and communication component 124. In an example, track display generator 120 may be used to generate a display of a track according to track layout information. In some examples, the track layout information may be received from base track segment 106, and may indicate a set of track segments (e.g., of one or more track segment types), as well as a layout associated with the set of track segments. In another example, track display generator 120 may generate a display of a track according to information received from game service 102 (e.g., as may be stored by track segment data store 114), such that a user of mobile device 104 may arrange a set of track segments (e.g., track segments 106-112) according to the generated display. In another example, track display generator 120 may generate a display according to information received from multiple sources (e.g., base track segment 106 and game service 102, etc.).

Track segment processor 122 may process track layout information as may be received from base track segment 106. In an example, the track layout information may comprise ordered data relating to a set of track segments. The ordered data may be a list of track segment identifiers, wherein the ordering may indicate the arrangement of the associated track segments. A track segment identifier may be a unique identifier associated with a specific type of track segment (e.g., a straight track segment, a curved track segment, an exotic track segment, a track segment that is colored, etc.). In some examples, track segment processor 122 may access information from track segment data store 114 in order to determine a track segment type associated with a track segment identifier. While track segment data store 114 is illustrated as part of game service 102, it will be appreciated that mobile device 104 may comprise a track segment data store in some examples, in addition to or as an alternative to track segment data store 114 of game service 102.

Mobile device 104 is also illustrated as comprising communication component 124. In an example, communication component 124 may be used by mobile device 104 to communicate with game service 102 and/or base track segment 106. As an example, communication component 124 may be used to engage in wired and/or wireless communication, including, but not limited to, over Ethernet, Bluetooth, Bluetooth Low Energy, Wi-Fi, and/or infrared light. While mobile device 104 is illustrated as having one communication component 124, it will be appreciated that, in some examples, multiple communication components may be used (e.g., each relating to one or more specific communication technologies, etc.).

As described herein, mobile device 104 may communicate with base track segment 106 to determine track layout information associated with track segments 106-112. For example, mobile device 104 may receive information from communication component 126 of base track segment 106 using communication component 124, which may be processed by track segment processor 122 according to aspects disclosed herein. Communication component 126 may be similar to communication component 124, and may support one or more communication technologies.

Base track segment 106 is also illustrated as comprising shift register 128. In an example, shift register 128 may be a parallel-in, serial-in, serial-out shift register, such that a track segment identifier may be loaded (e.g., via parallel-in) and output to communication component 126 (e.g., via serial-out). Further, shift register 128 may receive signals from shift registers 130, 132, and 136 (either directly and/or indirectly via one or more other shift registers) via serial-in. In some examples, base track segment 106 may comprise a processor, which may be used to further control communication component 126 and shift register 128.

As illustrated, track segments 106-112 are sequentially connected, such that shift registers 128, 130, 132, and 136 may also be sequentially connected. As described above, the connection may be via physical connectors, magnetic connectors, and/or wireless, among other techniques. In an example, each track segment may have a track segment identifier, which may uniquely identify the type of track segment. The unique identifier may be loaded into the shift register for the track segment (e.g., shift register 128, 130, 132, and/or 136 for track segment 106, 108, 110, and/or 112, respectively) via parallel-in. In some examples, the track segment identifier may be comprised of an 8-bit number or a 16-bit number, among other identifiers. In an 8-bit example, 8-bit shift registers may be used. In another example, a combination of 8-bit and 16-bit shift registers may be used, such that 16-bit identifiers may be indicated using a pre-determined unique identifier in order to indicate that a following series of bits should be interpreted as part of the same identifier. It will be appreciated that 8-bit and 16-bit identifiers are described herein as an example, and that any number of bits may be used.

Using serial-in and serial-out, the respective shift registers may shift the bits of the respective track segment identifiers toward base track segment 106, such that base track segment 106 may receive a bit stream comprising the track segment identifiers for each of track segments 108-112. For example, after the track segment identifier for base track segment 106, the bit stream may first comprise a track segment identifier for track segment 108, followed by a track segment identifier for track segment 110 and a track segment identifier for smart track segment 112. Briefly with respect to shift register 130 as an example, shift register 130 may receive bits from shift register 132 via serial-in, and may provide bits to shift register 128 via serial-out. Given that smart track segment 112 is the final track segment illustrated in system 100, zeros may follow the track segment identifier for smart track segment 112. Accordingly, base track segment 106 may determine that there is no more additional data to receive, after which the process may be repeated, thereby enabling repeated polling of the track in order to identify changes to the track layout.

Smart track segment 112 is illustrated as comprising processor 134. In some examples, processor 134 may introduce additional information in the bit stream, which may be processed at base track segment 106 and/or mobile device 104. In examples, the additional information may be processed by one or more other smart track segments. The additional information may be indicated using a pre-determined unique identifier, such that the additional information may be distinguished from ordinary track segment identifiers. Example additional information includes, but is not limited to, sensor information, one or more attributes relating to smart track segment 112, and/or custom content associated with smart track segment 112. In some examples, a track segment identifier may incorporate a parity bit, which may be used to identify (and potentially correct) transmission errors or shift errors, among other issues. While an example configuration is illustrated in system 100, it will be appreciated that a track may be comprised of any number and/or type of track segments in any of a variety of layouts, and that any number of mobile devices and/or game services may be used.

In some examples, base track segment 106 may comprise a memory in which to cache the received bit stream prior to transmitting the bit stream to mobile device 104 using communication component 126. In another example, the bit stream may be communicated to mobile device 104 as the bits are received by base track segment 106. Example techniques with which the bit stream may be read and communicated at base track segment 106 include, but are not limited to, using direct memory access (DMA) or via a serial peripheral interface (SPI) bus, among others.

In an example, a form of bidirectional communication may be achieved if the track is a loop (e.g., such that the base track segment may act as both the start of the track and the end of the track) or if an additional lead is added so as to insert bits into the bit stream that follows the bit stream comprising the track segment identifiers of the track segments, among other examples. Thus, even though information may flowing in only one direction (e.g., from smart track segment 112 to base track segment 106 via track segments 108 and 110), a base track segment may provide additional bits at the end of the bit stream, such that the bit stream incorporates the additional information after the track identifiers rather than merely ending with a series of zeros that indicate the end of the bit stream. In some examples, the additional information may be received by a smart track segment.

FIG. 1B illustrates an overview of example aspects of a track segment 150. As illustrated, track segment 150 comprises four leads at either side, each of which may be used to connect to a base track segment (e.g., base track segment 106 in FIG. 1B) or another track segment (e.g., one of track segments 108-112). On the left and right side of track segment 150, the leads comprise power 152, ground 154, and clock 156. These leads are illustrated as spanning track segment 150, such that they may connect to another track segment in order to pass power, ground, and the clock signal to a subsequent track segment. Track segment 150 also comprises data out lead 158 and data in lead 160. These leads may be used for the serial-out and serial-in operations, respectively, of shift register 162 according to aspects described herein. For example, data in lead 160 may receive signals from a shift register of another track segment, while data out lead 158 may shift bits out to another track segment. While shift register 162 is illustrated as having data out lead 158 and data in lead 162 such that the data out lead 158 would need to be connected to shift data toward a base track segment, other examples may comprise a shift register capable of configuring leads 158 and 160 to communicate in varying directions, so as to provide a track segment that can be connected in any orientation.

As illustrated, pins of shift register 162 is connected to power 152, ground 154, clock 156, data out lead 158, and data in lead 160. Pins of shift register 162 are also connected to resistors 164 and 166, which may be used during a parallel-in operation in order to load bits into the shift register. Resistors 164 are illustrated as being connected to +5V, such that bits of shift register 162 associated with these pins may be set to a 1, while resistors 166 are connected to ground, such that bits associated with these pins may be set to 0. Thus, as illustrated, the identifier of track segment 150 may be a sequence of bits comprising 11000100. This bit sequence may be loaded into shift register 162 via a parallel-in operation. Data in lead 160 is connected to ground, as illustrated by arrow 168, such that, if no track segment is connected, the input into shift register 162 will be a 0. In some examples, shift register 162 may comprise a load pin, which may be used to instruct shift register 162 to load the bits indicated by resistors 164 and 166. It will be appreciated that track segment 150 is provided as an example circuit, and that other techniques may be used to provide similar functionality. For example, rather than resistors, solder bridges may be used in order to assign an identifier to track segment 150 during manufacturing.

FIG. 1C illustrates an overview of an example circuit diagram for a track segment 170. In some examples, track segment 170 comprises female connector 172 and a male connector 174. As illustrated, female connector 172 comprises four pins: VCC, CLK, Serial In, and GND. Male connector 174 comprises four pins: VCC, CLK, Serial Out, and GND. According to aspects described herein, track segment 170 may be connected to one or more other track segments, such as a base track segment. In some examples, track segment 170 may be connected with other track segments, such that male connector 174 is directly or indirectly connected to a base track segment, while female connector 172 may be connected to additional track segments. In other examples, female connector 172 may be directly or indirectly connected to a base track segment, while male connector 174 may be connected to additional track segments. It will be appreciated that other examples of a track segment may operate regardless of which side (e.g., male or female connector) is used to connect to the base track segment.

Track segment 170 further comprises shift register 176, which may offer track layout identification functionality according to aspects disclosed herein. As illustrated, shift register 176 is connected to resistors R1-R16. In an example, resistors R1-R16 may be selectively populated in order to specify a specific track segment identifier. For example, only one resistor may be placed for each resistor couple (e.g., R1 and R9, R2 and R10, R3 and R11, R4 and R12, R5 and R13, R6 and R14, R7 and R15, and R8 and R16). In some examples, load pin 178A of shift register 176 may be used to load the bits specified by the configuration of resistors R1-R16. Circuitry 178B, as illustrated by the dashed box, is provided as an example circuit which may hold load pin 178A low for long enough to enable shift register 176 to load parallel data (e.g., as specified by R1-R16) when track segment 170 receives power.

It will be appreciated that track segment 170 is provided as an example circuit, and that other examples may be comprised of additional, fewer, or different components in a variety of other configurations. Further, resistor values, capacitor values, and other aspects of track segment 170 are provided as an example, and it will be appreciated that alternative values may be used.

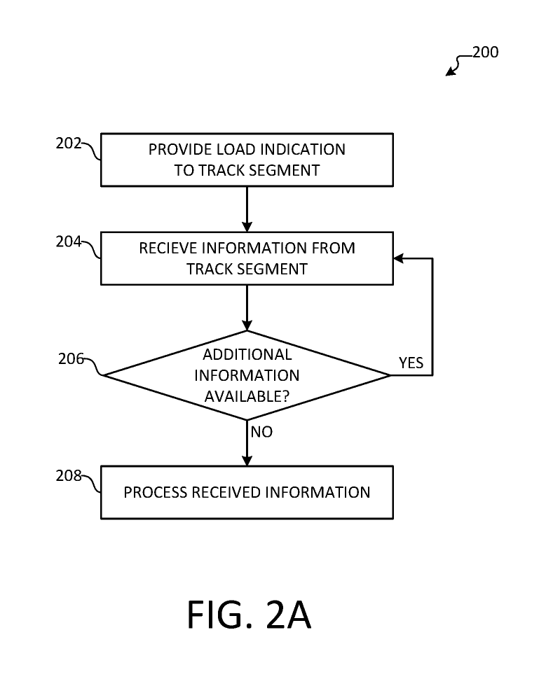

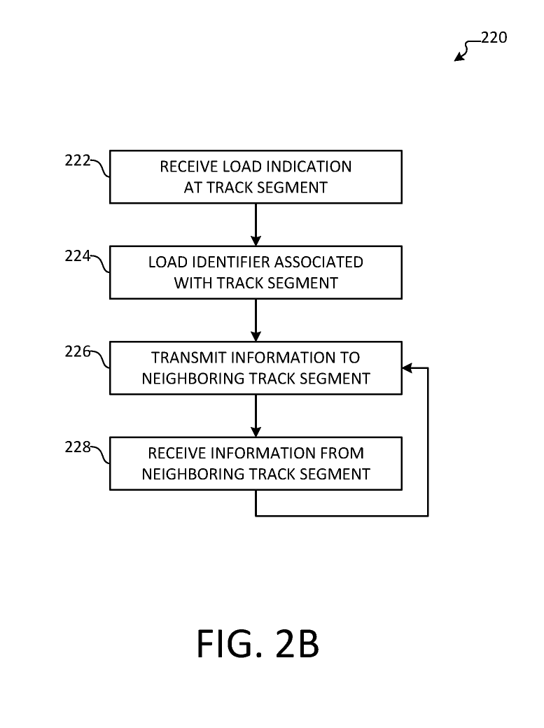

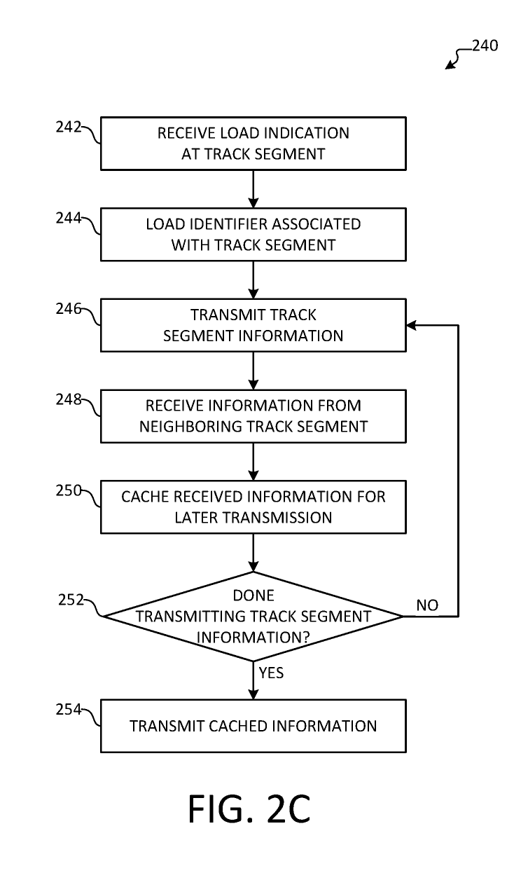

FIG. 2A illustrates an overview of an example method 200 for receiving track segment information at a base track segment. In an example, method 200 may be performed by base track segment 106 in FIG. 1A. Method 200 begins at operation 202, where a load indication may be provided to a track segment. In an example, the load indication may be provided to a plurality of track segments such as track segments 108-112 in FIG. 1A. In some examples, the load indication may be provided to the track segments via one or more other track segments, such as examples where the track segments are connected in series. The load indication may indicate to the track segment that an identifier associated with the track segment should be loaded in to a shift register (e.g., via a parallel-in operation), as described above with respect to FIGS. 1A-1B. In other examples, the load indication may be provided as a result of first providing power to the track segment, as discussed above with respect to circuitry 178B in FIG. 1C.

At operation 204, information may be received from a track segment. In some examples, the information may be received as a signal from a shift register of the track segment. For example, bits may be clocked in from the shift register at the frequency of a clock provided to the shift register by the base track segment. The information may comprise a bit stream having identifiers of one or more track segments (e.g., track segments 106-112 in FIG. 1A). In some examples, the bit stream may be comprised of 8-bit and/or 16-bit track segment identifiers and/or additional information, as may be communicated by a smart track segment according to aspects disclosed herein. In an example, the bit stream may be parsed as bytes, wherein each byte may be associated with a track segment. In another example, the order of the bytes may convey layout information of the track, such that the order of the track segments may be determined from the order of the bytes.

Moving to determination 206, it may be determined whether additional information is available. In some examples, the determination may comprise evaluating whether one or more track segment identifiers of zero (e.g., eight zeros for an 8-bit track segment identifier, 16 zeros for a 16-bit track segment identifier, etc.) was received as part of the bit stream. It will be appreciated that other track segment identifiers may be used for such determinations. If it is determined that additional information is available, flow branches “YES” to operation 204, where information may be received from the track segment. Flow may loop between operations 204 and 206 as long as track information continues to be received from the track segment.

If, however, it is determined that additional information is not available, flow branches “NO” to operation 208, where received information may be processed. In some examples, processing the received information may comprise communicating the information to a device, such as mobile device 104 in FIG. 1A. In other examples, the information may be processed by a processor (e.g., compressed, interpreted, etc.) prior to transmission to a device. Flow terminates at operation 208. In an example, one or more operations of method 200 may be repeated by a base track segment, so as to poll the track for track segment identifiers, in order to determine when a change to the track layout occurs.

FIG. 2B illustrates an overview of an example method 220 for communicating track segment information by a track segment. In an example, method 220 may be performed by a track segment, such as track segments 106-112 in FIG. 1A. Method 220 begins at operation 222, where a load indication may be received at the track segment. In an example, the load indication may be received directly or indirectly (e.g., via another track segment) from a base track segment (e.g., base track segment 106 in FIG. 1A). In some examples, the load indication may comprise providing power to a load pin of a shift register.

At operation 224, a track segment identifier associated with the track segment may be loaded. In an example, loading the track segment identifier may comprise a shift register loading bits based on the voltage of one or more pins of the shift register, as discussed above with respect to FIG. 1B. In an example, a track segment identifier may be an 8-bit or 16-bit value associated with the track segment that uniquely identifies the type of the track segment.

Moving to operation 226, information comprising the track segment identifier may be transmitted to a neighboring track segment. In some examples, the information may be transmitted by a shift register that shifts bits based on a clock signal received from a base track segment. As an example, the shift register may first shift out the bits (e.g., to the neighboring track segment) associated with the track segment identifier (e.g., which may have been loaded via a parallel-in operation), after which bits received as part of operation 228 may subsequently be shifted out.

Information from a different neighboring track segment may be received at operation 228, which may have been shifted out from the different neighboring track segment and shifted in to the instant track segment. While method 220 illustrates operations 226 and 228 as separate and potentially sequential operations, it will be appreciated that operations 226 and 228 may occur substantially contemporaneously such that data is shifted in and out at approximately the same time. Thus, the track segment may transmit a bit stream first comprising the loaded track segment identifier, after which the bit stream will comprise bits shifted in from a neighboring track segment. In some examples, no neighboring track segment may exist, such that zeros (or another identifier indicating that there is no neighboring track segment) may instead be shifted in. Flow may loop between operations 226 and 228 until the base track segment determines that no additional information is available (e.g., as discussed above at operation 206 in FIG. 2A), after which flow terminates at operation 228.

FIG. 2C illustrates an overview of an example method 240 for communicating track segment information by a smart track segment. In an example, method 240 may be performed by smart track segment 112 in FIG. 1A. Method 240 begins at operation 242, where a load indication may be received at the track segment. In an example, the load indication may be received directly or indirectly (e.g., via another track segment) from a base track segment (e.g., base track segment 106 in FIG. 1A). In some examples, the load indication may comprise providing power to a load pin of a shift register.

At operation 244, a track segment identifier associated with the track segment may be loaded. In an example, loading the track segment identifier may comprise a shift register loading bits based on the voltage of one or more pins of the shift register, as discussed above with respect to FIG. 1B. In an example, a track segment identifier may be an 8-bit or 16-bit value associated with the track segment that uniquely identifies the type of the track segment. In some examples, the track segment identifier may comprise an indication that the track segment is a smart track segment (e.g., based on the presence of a certain bit in the track segment identifier, the track segment identifier being within a certain range, etc.).

Moving to operation 246, track segment information may be transmitted to a neighboring track segment. In some examples, the information may be transmitted by a shift register that shifts bits based on a clock signal received from a base track segment. As an example, the shift register may first shift out the bits (e.g., to the neighboring track segment) associated with the track segment information (e.g., which may have been loaded via a parallel-in operation or provided by a processor), after which bits received as part of operation 228 may subsequently be shifted out (e.g., at operation 254). In some examples, a processor of the smart track segment may introduce bits into the bit stream, such that the track segment information may comprise the track segment identifier in conjunction with additional information. Example additional information includes, but is not limited to, sensor information, one or more attributes relating to the smart track segment (e.g., capabilities, size, color, etc.), and/or custom content associated with smart track segment (e.g., sounds, graphics, etc.).

Information from a different neighboring track segment may be received at operation 248, which may have been shifted out from the different neighboring track segment and shifted in to the instant track segment. While method 240 illustrates operations 246 and 248 as separate and potentially sequential operations, it will be appreciated that operations 246 and 248 may occur substantially contemporaneously such that data is shifted in and out at approximately the same time in some examples.

At operation 250, the received information may be cached for later transmission, such that the transmission of the track segment information may complete prior to transmitting the bit stream received from the neighboring track segment. Thus, the smart track segment may transmit a bit stream first comprising the track segment information, after which the bit stream will comprise bits shifted in from a neighboring track segment. In some examples, no neighboring track segment may exist, such that zeros (or another identifier indicating that there is no neighboring track segment) may instead be shifted in.

At determination 252, it may be determined whether the smart track segment is done transmitting track segment information. If it is determined that the transmission is not done, flow branches “NO” to operations 246-252, where track segment information may continue to be transmitted and received information may continue to be cached, as discussed above. If, however, it is determined that the transmission is done, flow instead branches “YES” to operation 254, where the cached information may be transmitted (e.g., shifted out to a neighboring track segment). Flow may remain at operation 254 until the base track segment determines that no additional information is available (e.g., as discussed above at operation 206 in FIG. 2A), after which flow terminates at operation 254.

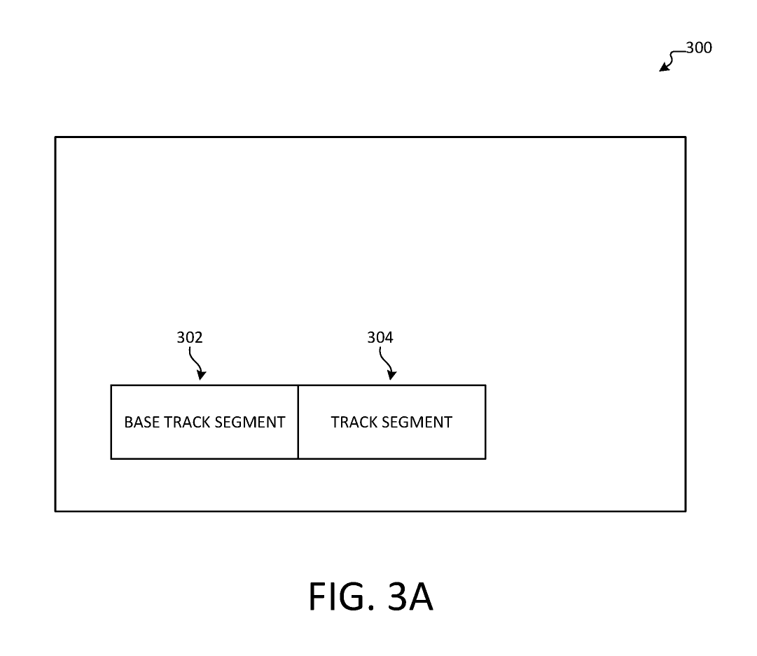

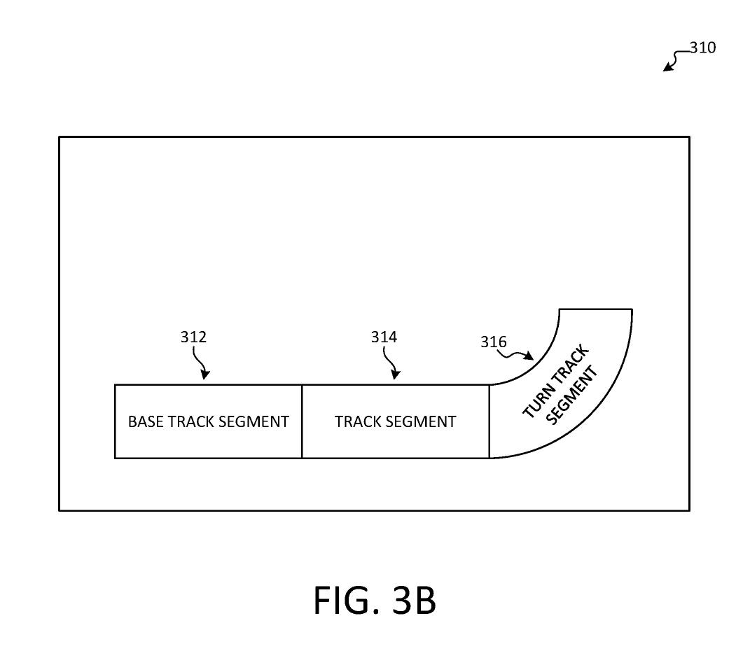

FIGS. 3A-3B illustrate overviews of example user interface elements according to aspects disclosed herein. As illustrated, FIG. 3A comprises user interface 300. In an example, user interface 300 may be provided on a device, such as mobile device 104 in FIG. 1A (e.g., as may have been generated by track display generator 120). User interface 300 may comprise a display of a track layout as may have been determined according to aspects disclosed herein. As illustrated, base track segment 302 is illustrated as being connected to track segment 304. This may have been determined as a result of base track segment 302 communicating a series of bytes comprising a track segment identifier for base track segment 302, followed by a track segment identifier for track segment 304. Accordingly, the track segment types and order of track segments may be determined and used to generate user interface 300.

Turning now to user interface 310 in FIG. 3B, user interface 310 comprises an updated view of a track, which may be generated as a result of a user adding a turn track segment to the track. Accordingly, as a result of polling the tracks segments, base track segment 312 may receive a bit stream comprising track segment identifiers for both track segment 314 and turn track segment 316 (as compared to merely receiving a bit stream comprising a track segment identifier for track segment 304, as was the case in FIG. 3A). Thus, user interface 310 may be updated to indicate that a track segment has been added to the track. Further, the track segment identifier may be used to determine that the added track segment is a left turn track segment, such that the display may be updated accordingly. It will be appreciated that while example track layouts and track segment types are discussed herein, any of a variety of layouts and segments may be used without departing from the spirit of this disclosure.

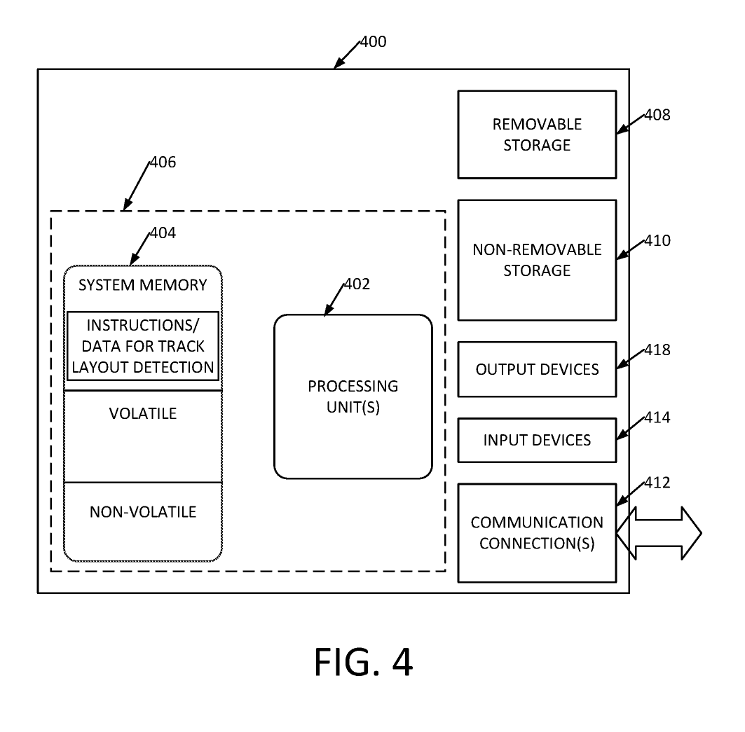

FIG. 4 illustrates an example operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically includes at least one processing unit 402 and memory 404. Depending on the exact configuration and type of computing device, memory 404 (e.g., instructions to perform the track layout detection techniques described herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system for track layout identification. The system comprises: a base track segment, comprising a clock and a connector to connect the base track segment to a first track segment; and the first track segment, comprising a shift register and a first connector to connect to the base track segment, wherein the shift register is configured to load a first track segment identifier associated with the first track segment and to provide the first track segment identifier at a frequency of the clock to the base track segment. In an example, the first track segment further comprises a second connector to connect to a second track segment, and the shift register is further configured to receive a second track segment identifier associated with the second track segment using the second connector and to provide the second track segment identifier to the base track segment using the first connector. In another example, the base track segment further comprises a processor and a communication component. In a further example, the processor is configured to perform a method comprising: providing an indication to load the first track segment identifier to the first track segment; receiving information from the first track segment; and transmitting the information to a computing device using the communication component. In yet another example, the processor periodically performs the method. In a further still example, the method further comprises: receiving, from the computing device, content for presentation to a user; and conveying the received content to the user. In another example, the connector of the base track segment and the first connector of the first track segment each comprise leads for power, ground, clock, and data.

In another aspect, the technology relates to a system for track layout identification by a track segment. The system comprises: a set of leads operable to connect the track segment to a first neighboring track segment and a second neighboring track segment, wherein the set of leads comprises a power lead, a ground lead, a clock lead, a data-in lead, and a data-out lead; a shift register configured to: load a track segment identifier associated with the track segment; transmit the track segment identifier using the data-out lead based on a frequency received at the clock lead; and receive information from the data-in lead. In an example, the system further comprises a set of resistors configured to define the track segment identifier associated with the track segment. In another example, the system further comprises a processor and a memory, wherein the memory is configured to cache information received from the data-in lead. In a further example, the processor is configured to transmit additional information using the data-out lead. In yet another example, the track segment comprises: a first connector and a second connector; wherein the first connector comprises: the power lead; the ground lead; the clock lead; and the data-in lead; and wherein the second connector comprises: the power lead; the ground lead; the clock lead; and the data-out lead. In a further still example, the data-in lead is useable as the data-out lead, and the data-out lead is useable as the data-in lead.

In a further aspect, the technology relates to a method for transmitting track segment information. The method comprises: in response to receiving a load indication, loading a track segment identifier associated with a track segment into a shift register; transmitting track segment information comprising the track segment identifier using the shift register, wherein the track segment information further comprises additional track segment information generated by a processor; receiving transmitted information from a neighboring track segment; caching the received information; and when it is determined that there is no additional track segment information to transmit, transmitting the cached received information using the shift register. In an example, the method further comprises: processing at least a part of the received information to determine that information was received from a base track segment; when it is determined that information is received from the base track segment, generating a response; and transmitting the response as part of the additional track segment information. In another example, the load indication comprises receiving power from a base track segment. In a further example, loading the track segment identifier comprises evaluating the voltage on one or pins of the shift register. In yet another example, the track segment identifier is defined by a set of resistors of the track segment. In a further still example, the track segment information is transmitted at a frequency of a clock of a base track segment. In another example, the track segment information comprises an indication that the track segment is a smart track segment.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system for track layout identification, comprising:
a base track segment, comprising a clock and a connector to connect the base track segment to a first track segment; and
the first track segment, comprising a shift register and a first connector to connect to the base track segment, wherein the shift register is configured to load a first track segment identifier associated with the first track segment and to provide the first track segment identifier at a frequency of the clock to the base track segment.

2. The system of claim 1, wherein the first track segment further comprises a second connector to connect to a second track segment, and wherein the shift register is further configured to receive a second track segment identifier associated with the second track segment using the second connector and to provide the second track segment identifier to the base track segment using the first connector.

3. The system of claim 1, wherein the base track segment further comprises a processor and a communication component.

4. The system of claim 3, wherein the processor is configured to perform a method comprising:
providing an indication to load the first track segment identifier to the first track segment;
receiving information from the first track segment; and
transmitting the information to a computing device using the communication component.

5. The system of claim 4, wherein the processor periodically performs the method.

6. The system of claim 4, wherein the method further comprises:
receiving, from the computing device, content for presentation to a user; and
conveying the received content to the user.

7. The system of claim 1, wherein the connector of the base track segment and the first connector of the first track segment each comprise leads for power, ground, clock, and data.

8. A system for track layout identification by a track segment, comprising:
a set of leads operable to connect the track segment to a first neighboring track segment and a second neighboring track segment, wherein the set of leads comprises a power lead, a ground lead, a clock lead, a data-in lead, and a data-out lead;
a shift register configured to:
load a track segment identifier associated with the track segment;
transmit the track segment identifier using the data-out lead based on a frequency received at the clock lead; and
receive information from the data-in lead.

9. The system of claim 8, further comprising a set of resistors configured to define the track segment identifier associated with the track segment.

10. The system of claim 8, further comprising a processor and a memory, wherein the memory is configured to cache information received from the data-in lead.

11. The system of claim 10, wherein the processor is configured to transmit additional information using the data-out lead.

12. The system of claim 8, wherein the track segment comprises:
a first connector and a second connector;
wherein the first connector comprises:
the power lead;
the ground lead;
the clock lead; and
the data-in lead; and
wherein the second connector comprises:
the power lead;
the ground lead;
the clock lead; and
the data-out lead.

13. The system of claim 8, wherein the data-in lead is useable as the data-out lead, and the data-out lead is useable as the data-in lead.

14. A method for transmitting track segment information, comprising:
in response to receiving a load indication, loading a track segment identifier associated with a track segment into a shift register;
transmitting track segment information comprising the track segment identifier using the shift register, wherein the track segment information further comprises additional track segment information generated by a processor;
receiving transmitted information from a neighboring track segment;
caching the received information; and
when it is determined that there is no additional track segment information to transmit, transmitting the cached received information using the shift register.

15. The method of claim 14, further comprising:
processing at least a part of the received information to determine that information was received from a base track segment;
when it is determined that information is received from the base track segment, generating a response; and
transmitting the response as part of the additional track segment information.

16. The method of claim 14, wherein the load indication comprises receiving power from a base track segment.

17. The method of claim 14, wherein loading the track segment identifier comprises evaluating the voltage on one or pins of the shift register.

18. The method of claim 14, wherein the track segment identifier is defined by a set of resistors of the track segment.

19. The method of claim 14, wherein the track segment information is transmitted at a frequency of a clock of a base track segment.

20. The method of claim 14, wherein the track segment information comprises an indication that the track segment is a smart track segment.
